(19) United States
(12) Patent Application Publication
(10) Pub. No.: US 2024/0010219 A1
(43) Pub. Date: Jan. 11, 2024

(54) DRIVING EVALUATION DISPLAY DEVICE, DRIVING EVALUATION DISPLAY METHOD, AND STORAGE MEDIUM

(71) Applicant: TOYOTA JIDOSHA KABUSHIKI KAISHA, Aichi-ken (JP)

(72) Inventor: Toko TAGA, Toyota-shi (JP)

(21) Appl. No.: 18/310,540

(22) Filed: May 2, 2023

(30) Foreign Application Priority Data
Jul. 8, 2022 (JP) 2022-110663

(51) Int. Cl. B60W 50/14; G06T 11/00; G06T 3/00

(52) U.S. Cl. CPC B60W 50/14; G06T 11/001; G06T 3/00; B60W 2540/30

(57) ABSTRACT

The driving evaluation display device acquires an evaluation result of a driving operation of a driver based on operation data regarding the driving operation during traveling, and causes an evaluation image indicating the acquired evaluation result to be displayed on a display unit provided forward of a driver's seat. The evaluation image is displayed in conjunction with the start of the driving operation by the driver, and the display mode of at least a part of the evaluation image changes based on the evaluation result of the driving operation.

### CROSS-REFERENCE TO RELATED APPLICATION

This application claims priority to Japanese Patent Application No. 2022-110663 filed on Jul. 8, 2022, incorporated herein by reference in its entirety.

### BACKGROUND

### 1. Technical Field

The present disclosure relates to a driving evaluation display device, a driving evaluation display method, and a storage medium.

### 2. Description of Related Art

Japanese Unexamined Patent Application Publication No. 2011-159215 (JP 2011-159215 A) discloses a driving evaluation information display device that presents to a driver, as an operation assistance screen, the most recent evaluation regarding the driving operation up to a predetermined point in time during traveling. The driving evaluation information display device evaluates each driving operation performed within a predetermined period of time in the past, and reflects the result of the most recent evaluation on the operation assistance screen, taking into account the average evaluation score and the number of penalties within a predetermined period of time. The operation assistance screen displays an image of waves of which wave height, period, display color, etc. change in accordance with the evaluation results, making it intuitively understandable to the driver while driving.

### SUMMARY

However, in the technique described in JP 2011-159215 A, the comprehensive evaluation result of the most recent driving operation is presented to the driver based on the evaluation scores of various driving operations performed within a predetermined period of time. Therefore, there is a time lag between the timing at which the driver obtains a sense of operation when performing the driving operation and the timing at which the evaluation result is displayed, and it may be difficult for the driver to intuitively understand the evaluation result for a specific operation. Therefore, the above-mentioned related art has room for improvement in this respect.

In consideration of the fact above, an object of the present disclosure is to provide a driving evaluation display device, a driving evaluation display method, and a storage medium that enable a driver to intuitively understand an evaluation result of a driving operation.

A driving evaluation display device according to claim 1 includes: an evaluation acquisition unit that acquires an evaluation result of a driving operation of a driver based on operation data regarding the driving operation during traveling; and a display control unit that causes a display unit provided forward of a driver's seat to display an evaluation image indicating the evaluation result acquired by the evaluation acquisition unit. The display control unit causes the evaluation image to be displayed in conjunction with a start of the driving operation by the driver, and changes a display mode of at least a part of the evaluation image based on the evaluation result.

In the driving evaluation display device according to claim 1, the evaluation result of the driving operation of the driver that is evaluated based on the operation data regarding the driving operation during traveling is acquired. The evaluation result is displayed as the evaluation image on the display unit provided forward of the driver's seat. Thus, the driver in the driver's seat can see the evaluation image and can know how the driving operation is evaluated.

Here, the evaluation image is displayed in conjunction with the start of the driving operation by the driver, and the display mode of at least a part of the evaluation image changes based on the evaluation result of the driving operation. Thus, when the driver starts the driving operation to be evaluated, the evaluation image is displayed in time with the timing of obtaining a sense of operation, so that the driver can intuitively understand about the driving operation to be evaluated. Further, by changing the display mode of the evaluation image based on the evaluation result, it is possible to display the evaluation result in accordance with the sense of operation in a mode that is intuitively easy to understand.

In the driving evaluation display device according to claim 2, in the configuration according to claim 1, the evaluation image may be a graphic image, and the display control unit may distort the shape of the evaluation image based on the evaluation result.

In the driving evaluation display device according to claim 2, by changing the shape of the graphic image based on the evaluation result, it is possible to display the evaluation result in a manner that is intuitively easy for the driver to understand.

In the driving evaluation display device according to claim 3, in the configuration according to claim 1, the evaluation image may be a graphic image, and the display control unit may change a color of an outer peripheral portion of the evaluation image based on the evaluation result.

In the driving evaluation display device according to claim 3, by changing the color of the outer peripheral portion based on the evaluation result, it is possible to display the evaluation result in a manner that is intuitively easy for the driver to understand.

In the driving evaluation display device according to claim 4, in the configuration according to claim 1, when a driving state of a vehicle changes from a traveling state to a stopped state, the display control unit may cause the display unit to display an evaluation distribution image showing a distribution of evaluation results for a plurality of driving operations in a predetermined section.

In the driving evaluation display device according to claim 4, when the driving state of the vehicle changes from a traveling state to a stopped state, the evaluation distribution image is displayed on the display unit. The evaluation distribution image shows the distribution of the evaluation results for a plurality of driving operations in a predetermined section. As a result, the evaluation distribution regarding the driving operations in the section to be evaluated is presented to the driver while the vehicle is stopped, that is, the presentation does not interfere with the driving operation. As a result, the driver can make improvements while objectively grasping the tendency of his/her own driving operation.

A driving evaluation display method according to claim 5 includes: acquiring an evaluation result of a driving operation of a driver based on operation data regarding the driving operation during traveling; and displaying an evaluation image indicating the acquired evaluation result on a display unit provided forward of a driver's seat. In the driving evaluation display method, the evaluation image is displayed in conjunction with a start of the driving operation by the driver, and a display mode of at least a part of the evaluation image is changed based on the evaluation result.

A storage medium according to claim 6 stores a driving evaluation display program that causes a computer to execute processes that include: acquiring an evaluation result of a driving operation of a driver based on operation data regarding the driving operation during traveling; and displaying an evaluation image indicating the acquired evaluation result on a display unit provided forward of a driver's seat. In the driving evaluation display program, the evaluation image is displayed in conjunction with a start of the driving operation by the driver, and a display mode of at least a part of the evaluation image is changed based on the evaluation result.

As described above, the driving evaluation display device, the driving evaluation display method, and the storage medium according to the present disclosure have an excellent effect that the driver can intuitively understand the evaluation result of the driving operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an overall configuration of a driving evaluation system according to an embodiment;

FIG. 2 is a schematic view of a front portion inside a vehicle cabin of a vehicle to which a driving evaluation display device according to the embodiment is applied, as viewed from the rear side of the vehicle;

FIG. 3 is a block diagram showing a hardware configuration of the driving evaluation display device according to the embodiment;

FIG. 4 is a block diagram showing a functional configuration of the driving evaluation display device according to the embodiment;

FIG. 5 is a diagram showing an example of an evaluation image according to the embodiment;

FIG. 6 is a diagram showing an example of an evaluation distribution image according to the embodiment; and

FIG. 7 is a diagram showing an example of an evaluation image and an evaluation distribution image according to a modification.

### DETAILED DESCRIPTION OF EMBODIMENTS

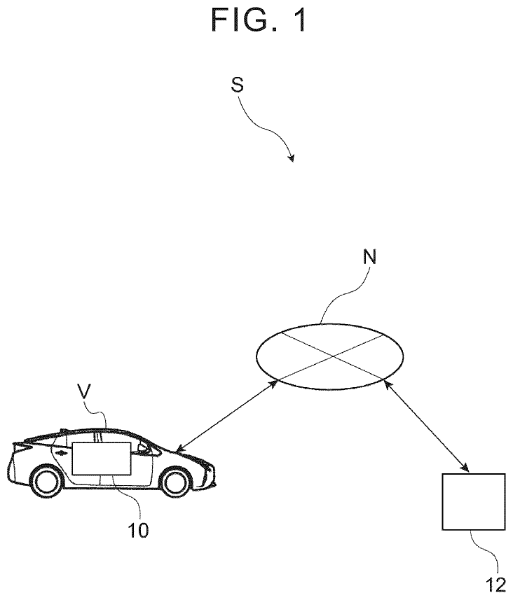

A driving evaluation system S including a driving evaluation display device 10 according to the present embodiment will be described below with reference to FIGS. 1 to 6.

As shown in FIG. 1, the driving evaluation system S of the present embodiment is configured to include the driving evaluation display device 10 mounted on a vehicle V, and a server 12. The vehicle V and the server 12 are connected by a network N. Although a plurality of vehicles V is connected to the network N, only one vehicle V is shown in FIG. 1 for convenience of explanation.

As an example, the driving evaluation display device 10 of the present embodiment is a control device provided in the vehicle V.

The server 12 is a server owned by a manager of the vehicles V. That is, the manager who manages the vehicles V owns the server 12, and as an example in the present embodiment, the vehicle V is a vehicle used as a taxi that carries a user. The server 12 is owned by a taxi company.

Here, in the vehicle V, operation data of a driving operation performed by the driver during traveling is acquired and transmitted to the server 12. The server 12 evaluates the driving operation of the driver based on the operation data by executing a pre-stored program. The driving evaluation display device 10 acquires an evaluation result of the driving operation, and an evaluation image reflecting the evaluation result is caused to be displayed on a display unit 23 (23A, 23B, 23C) provided forward of a driver's seat of the vehicle V.

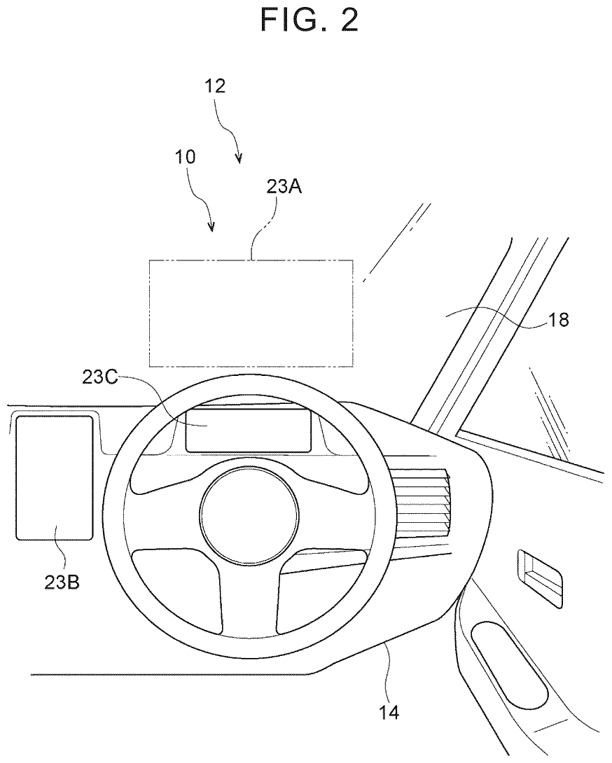

The display unit 23 is illustrated. As shown in FIG. 2, the display unit 23 is constituted by a display provided on a front portion inside a vehicle cabin of the vehicle V.

The display unit 23 may be constituted by a meter display 23A provided forward of the driver's seat in the front-rear direction of the vehicle on one side (the right side in FIG. 2) of the instrument panel 14 in the vehicle width direction.

The display unit 23 may be constituted by a display 23B provided forward of the driver's seat in the front-rear direction of the vehicle in the center portion of the instrument panel 14 in the vehicle width direction.

The display unit 23 may be constituted by a projection surface 23C (windshield glass 18) of a head-up display device (not shown) located forward of the instrument panel 14 in the front-rear direction of the vehicle. In this case, the driving evaluation display device 10 is included in the head-up display device.

The display unit 23 may be a display of a user terminal installed forward of the driver's seat. The user terminal is, for example, a mobile terminal represented by a smart phone, a tablet, or the like. In this case, the driving evaluation display device 10 may be an external component of the user terminal or an internal component of the user terminal.

Hardware Configuration of Driving Evaluation Display Device 10

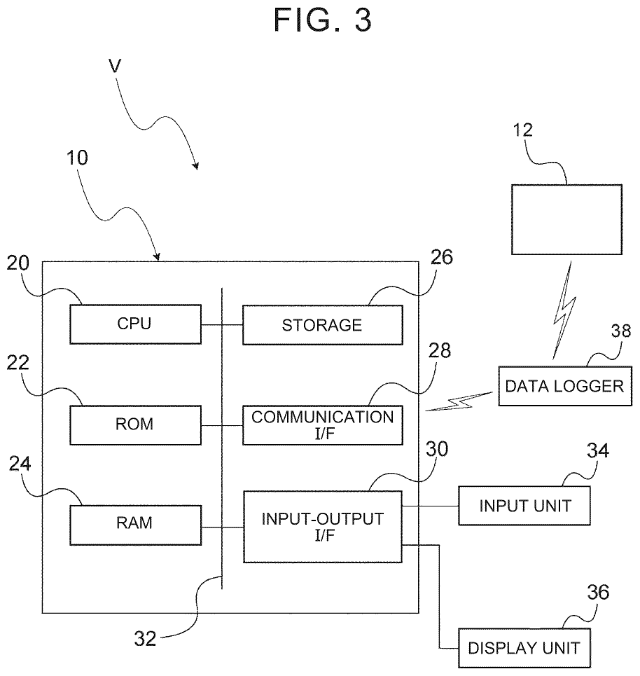

FIG. 3 is a block diagram showing a hardware configuration of the driving evaluation display device 10. As shown in FIG. 3, the driving evaluation display device 10 is configured to include a central processing unit (CPU: processor) 20, a read-only memory (ROM) 22, a random access memory (RAM) 24, a storage 26, a communication interface (communication I/F) 28, and an input-output interface (input-output I/F) 30. The configurations are connected to each other so as to be able to communicate with each other via a bus 32.

The CPU 20 is a central processing unit that executes various programs and that controls various units. That is, the CPU 20 reads a program from the ROM 22 or the storage 26 and executes the program using the RAM 24 as a work area. The CPU 20 controls each of the above configurations and executes various arithmetic processes in accordance with the program recorded in the ROM 22 or the storage 26.

The ROM 22 stores various programs and various data. The RAM 24 temporarily stores a program or data as a work area. The storage 26 is composed of a hard disk drive (HDD) or a solid state drive (SSD), stores various programs including an operating system, and stores various data. In the present embodiment, the ROM 22 or the storage 26 stores a program for performing a driving evaluation display process, various data, and the like.

The communication I/F 28 is an interface used for the driving evaluation display device 10 to communicate with the server 12 and other devices such as a data logger 38 to be described later, and for example, standards such as a controller area network (CAN), Ethernet (registered trademark), long term evolution (LTE), fiber distributed data interface (FDDI), and Wi-Fi (registered trademark) are used.

Here, the communication I/F 28 communicates with the data logger 38 mounted on the vehicle V.

The data logger 38 is configured to be able to communicate with electronic control units (ECUs) mounted on various in-vehicle sensors via in-vehicle networks such as CAN and Ethernet (registered trademark). The in-vehicle sensor is a sensor group for detecting the operation data regarding the driving operation of the driver. The type of the in-vehicle sensor is not particularly limited. The in-vehicle sensor can be composed of, for example, an internal camera that captures inside the cabin of the vehicle V, an external camera that captures the surroundings of the vehicle V, a driving monitor, an accelerator position sensor, a brake sensor, and the like.

The data logger 38 of the present embodiment can acquire the operation data regarding the driving operation of the driver that is detected by the in-vehicle sensor and transmit the data to the driving evaluation display device 10 via the communication I/F 28. The data logger 38 also transmits the acquired operation data to the server 12. The server 12 accumulates the operation data transmitted from the data logger 38.

The input-output I/F 30 is electrically connected to an input unit 34 and a display unit 36. The input unit 34 is a device for inputting a predetermined instruction to the driving evaluation display device 10, and is composed of, for example, operation buttons and an operation panel installed around the driver's seat. The display unit 36 is a device such as a display for displaying information output from the driving evaluation display device 10. Further, when the driving evaluation display device is composed of a tablet or the like, the input unit 34 and the display unit 36 may be integrated in a touch operation type display or the like.

Functional Configuration of Driving Evaluation Display Device 10

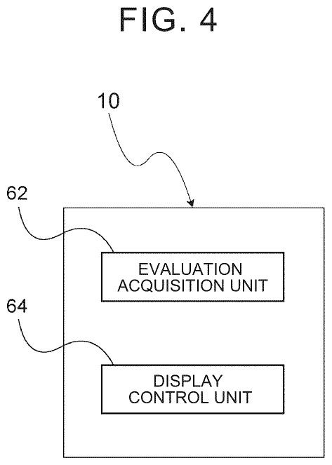

The driving evaluation display device 10 realizes various functions by using the above hardware resources. Functional configurations realized by the driving evaluation display device 10 will be described with reference to FIG. 4.

As shown in FIG. 4, the driving evaluation display device 10 is configured to include an evaluation acquisition unit 62 and a display control unit 64 as functional configurations. Each functional configuration is realized as the CPU 20 reads and executes the program stored in the ROM 22 or the storage 26.

The evaluation acquisition unit 62 acquires, for a preset driving operation, an evaluation result based on operation data acquired during traveling. In an example of the present embodiment, the evaluation result is calculated by executing a program stored in the server 12. The evaluation acquisition unit 62 acquires the evaluation result of the driving operation of the driver by receiving the evaluation result transmitted from the server 12.

Method for Evaluating Driving Operation

An example of a method for evaluating driving operations will be described. In the present embodiment, an accelerator operation and a brake operation of the driver are evaluated. Specifically, for each operation, a quantitative score is calculated based on the operation data acquired during traveling, and based on the calculated score, a three-level evaluation result is calculated, that is, the evaluation for each operation is calculated as “determined as OK”, “determined as NG”, or “determined as dangerous”.

“Determined as OK” is an evaluation result indicating that the driving operation is good. “Determined as NG” is an evaluation result indicating that the driving operation is unsatisfactory. “Determined as dangerous” is an evaluation result indicating that the operation has a high risk of threatening safe traveling of the vehicle V.

As the accelerator operation, evaluation is performed for each of start and sudden acceleration. Specifically, an accelerator operation amount detected by an accelerator position sensor and the time taken to reach a predetermined accelerator operation amount are acquired as the operation data.

For example, in the item of start, the score may be calculated based on the time from when the vehicle V is in a stopped state to when the predetermined accelerator operation amount is reached. In addition, the score of the most ideal start state may be set to 100, and the score of the start state in which the accelerator operation amount is maximum from the stopped state may be set to zero, and the score may be calculated by comparing the start states with the actual start state.

In the item of sudden acceleration, the degree of the sudden acceleration is calculated as a score. The amount of change in the accelerator operation amount detected by the accelerator position sensor and the time taken to reach the predetermined amount of change are acquired as the operation data. A low score may be calculated when the predetermined amount of change is reached in a relatively short time.

As the brake operation, evaluation is performed for each of sudden braking and stopping. In the item of sudden braking, the degree of the sudden braking is calculated as a score. For example, an amount of change in depression of a brake pedal that is detected by a brake sensor and the time taken to reach a predetermined amount of change are acquired as the operation data. A low score may be calculated when the predetermined amount of change is reached in a relatively short time. In addition, in the item of stopping, the score may be calculated based on the time required for the vehicle V to stop from a predetermined speed.

Note that the calculation of the scores for the accelerator operation and the brake operation may be performed based on an acceleration sensor provided in the vehicle V. That is, the start, sudden acceleration, sudden braking, and stopping of the vehicle may be determined based on the amount of change in acceleration within a predetermined period of time, and the score may be calculated based on the degree of these items.

The server 12 holds, in advance, a table in which operation items, scores, and evaluation results are associated with each other for the accelerator operation and the brake operation, and the driving operation is evaluated by referring to this table.

The evaluation of the driving operation described above may be performed, for example, at predetermined time intervals.

In the present embodiment, the evaluation of the driving operation of the driver is configured to be performed by executing a program stored in the server 12. However, the present disclosure is not limited to this. The evaluation of the driving operation may be configured to be performed by the driving evaluation display device 10. In this case, for example, similar to the usage form of a known application service provider (ASP), the driving evaluation display device 10 may execute the application software stored in the server 12 via the network N, and the driving operation may be evaluated by a function realized by the application software. In this case, the driving evaluation display device 10 evaluates the driving operation by executing the application software based on the operation data received from the data logger 38. Alternatively, the driving operation may be evaluated by the driving evaluation display device 10 by executing a program stored in the driving evaluation display device 10 in advance.

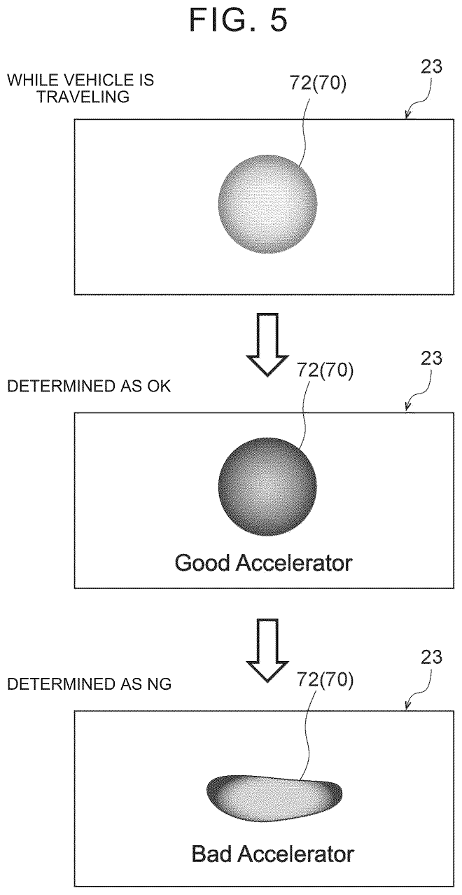

The display control unit 64 causes the display unit 23 mounted on the vehicle V to display the evaluation result acquired by the evaluation acquisition unit 62. Specifically, while the vehicle V is traveling, the display control unit 64 causes the display unit 23 to display an evaluation image 70 (see FIG. 5) showing the evaluation result using the graphic image 72. Through the evaluation image, the evaluation result for each of the most recent operations performed by the driver can be displayed.

The display mode of the evaluation image 70 will be specifically described with reference to the example shown in FIG. 5. The example in FIG. 5 shows the evaluation results for the accelerator operation of the driver. The evaluation image 70 displays a circular graphic image 72 in the center of the display screen, and presents the evaluation result to the driver by changing the color and the shape of the graphic image 72. Although the graphic image 72 is shown as a three-dimensional spherical image in FIG. 5, it may be a two-dimensional circular image.

Specifically, as shown in the upper diagram of FIG. 5, in the evaluation image 70, when a start of the accelerator operation by the driver is detected while the vehicle is traveling, the graphic image 72 is displayed in the center of the display screen in conjunction with the start of the operation. This allows the driver who looks at the display unit 23 to intuitively understand that the most recently started accelerator operation is being evaluated. Note that, in the example of the embodiment, a graphic image 72 is displayed in an inconspicuous gray color tone until the evaluation result of the driving operation is reflected.

Next, the display control unit 64 intuitively presents the evaluation result to the driver by changing the color and the shape of the graphic image 72 based on the acquired evaluation result. Specifically, as shown in the middle diagram of FIG. 5, when the evaluation result is “determined as OK”, the circular graphic image 72 is displayed in a state approximating a perfect circle, and the graphic image is displayed in a blue color tone. Further, in the present embodiment, text information “Good Accelerator” indicating that the accelerator operation is good is displayed below the graphic image 72.

On the other hand, as shown in the lower diagram of FIG. 5, when the evaluation result is “determined as NG”, the shape of the circular graphic image 72 is distorted and displayed flat, and the graphic image 72 is displayed in a yellow color tone. Further, in the present embodiment, text information “Bad Accelerator” indicating that the accelerator operation is unsatisfactory is displayed below the graphic image 72. It should be noted that the magnitude of distortion of the graphic image 72 may be changed so as to increase as the count number of “unsatisfactory” evaluations during traveling in a predetermined section increases.

Similarly, the evaluation image for the brake operation can indicate “good” and “unsatisfactory” by changing the color and the shape of the graphic image 72.

Although not shown, the evaluation result of “determined as dangerous” is calculated when sudden start, sudden acceleration, sudden braking, and sudden stopping are performed in such a degree that the safe traveling of the vehicle V is threatened. In this case, the evaluation image 70 is, for example, displayed in such a manner that the display mode of the graphic image 72 is emphasized compared to the display of other evaluation results, and is displayed to call the driver's attention. For example, the graphic image 72 may be enlarged over time to give a visual effect of approaching the driver, and the graphic image 72 may be displayed in a red color tone.

In this way, the driver can intuitively recognize the evaluation result of the driving operation through the change in the color and the shape of the graphic image 72.

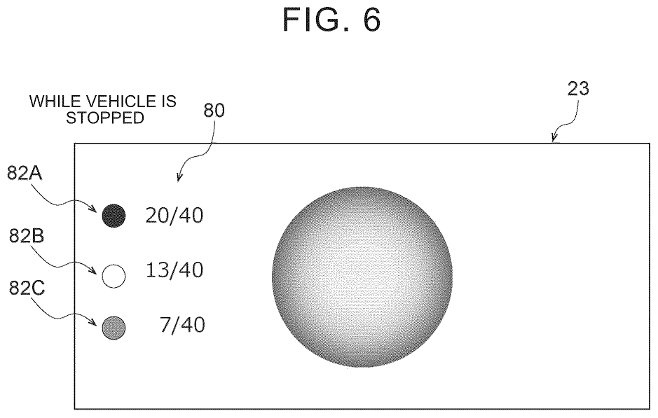

Further, as shown in FIG. 6, the display control unit 64 causes the display unit 23 to display an evaluation distribution image 80 when the driving state of the vehicle V changes from a traveling state to a stopped state. The evaluation distribution image 80 shows the distribution of the evaluation results for a plurality of driving operations during traveling in a predetermined section, and includes a plurality of circular graphic images 82 shown in different color tones corresponding to the evaluation results. In an example of the present embodiment, the graphic image 82A indicating “determined as OK” is displayed in a blue color tone, the graphic image 82B indicating “determined as NG” is displayed in a yellow color tone, and the graphic image 82C indicating “determined as dangerous” is displayed in a red color tone. Next to each graphic image 82, the number of times each evaluation result was calculated with respect to the total number of evaluations within a predetermined section is presented by text information. For example, according to FIG. 6, it can be seen that the accelerator operation is evaluated 40 times within the predetermined section, and the evaluation result indicating “determined as OK” is calculated 20 times. In this way, while the vehicle is stopped, the driver can quantitatively and objectively grasp the tendency of his/her own driving operation within the predetermined section. This makes it easier to encourage the driver to improve his/her driving operation when the driver resumes driving thereafter.

Note that the predetermined section may be, for example, a section from the most recent start until the vehicle V is stopped, a section from start until the vehicle V travels a predetermined distance, or a section the vehicle has traveled from start of the engine until the engine stops.

Operation and Effects

As described above, in the driving evaluation display device 10 of the present embodiment, the evaluation result of the driving operation of the driver is displayed on the display unit 23 as an evaluation image. At this time, the evaluation image 70 is displayed in conjunction with the start of the driving operation by the driver, and the display mode of at least a part of the evaluation image changes based on the evaluation result of the driving operation.

Specifically, in the example of the present embodiment, the evaluation image 70 is a graphic image 72, and the shape of the evaluation image 70 is distorted and displayed, based on the acquired evaluation result (see FIG. 5).

Thus, when the driver starts the driving operation to be evaluated, the evaluation image 70 is displayed in time with the timing of obtaining a sense of operation, so that the driver can intuitively understand about the driving operation to be evaluated. Further, by changing the display mode of the evaluation image 70 based on the evaluation result, it is possible to display the evaluation result in accordance with the sense of operation in a mode that is intuitively easy to understand.

Further, in the present embodiment, when the driving state of the vehicle changes from a traveling state to a stopped state, the evaluation distribution image 80 is displayed on the display unit (see FIG. 6). The evaluation distribution image 80 shows the distribution of the evaluation results for a plurality of driving operations in the predetermined section. As a result, the evaluation distribution regarding the driving operations in the section to be evaluated is presented to the driver while the vehicle is stopped, that is, the presentation does not interfere with the driving operation. As a result, the driver can make improvements while objectively grasping the tendency of his/her own driving operation.

Supplementary Explanation

The driving evaluation display device 10 according to the present embodiment has been described above. However, it is understood that the driving evaluation display device 10 can be implemented in various modes without departing from the scope of the present disclosure.

Modification of Evaluation Image and Evaluation Distribution Image

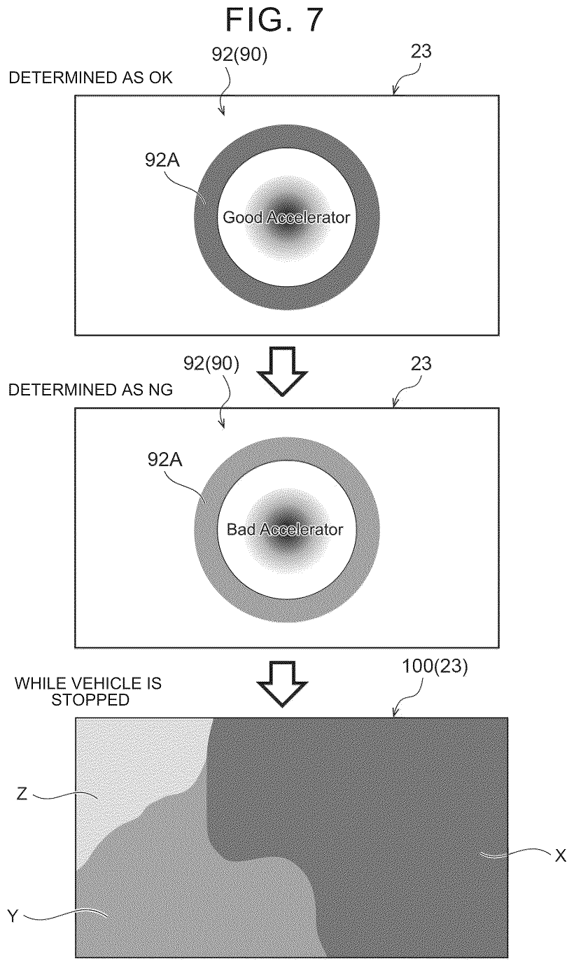

For example, in the above-described embodiment, a display mode has been described in which the driver is notified of the determination result by distorting the shape of the graphic image. However, the present disclosure is not limited to this. As shown in the upper and middle diagrams of FIG. 7, the evaluation image 90 may be displayed as a circular graphic image 92, and the driver may be notified of the evaluation result by changing the color of the outer peripheral portion 92A of the graphic image 92 based on the evaluation result. In this example, when “determined as OK” is calculated for the driving operation of the driver, the outer peripheral portion 92A of the graphic image 92 is displayed in a blue color tone. On the other hand, when “determined as NG” is calculated for the driving operation of the driver, the outer peripheral portion 92A of the graphic image 92 is displayed in a yellow color tone.

In addition, as shown in the lower diagram of FIG. 7, in a modification, when the driving state of the vehicle changes from a traveling state to a stopped state, the distribution of the evaluation results for a plurality of driving operations in a predetermined section is displayed using the evaluation distribution image 100 consisting of a gradation image. In FIG. 7, a gradation image including a display area X displaying a blue color tone indicating “determined as OK”, a display area Y displaying a yellow color tone indicating “determined as NG”, and a display area Z displaying a red color tone indicating “determined as dangerous” is presented on the display unit 23 as the evaluation distribution image 100. Each display area is displayed such that the size thereof increases in proportion to the count number of each evaluation. Therefore, according to FIG. 7, since the display area X has the largest display area, it can be intuitively known that the number of “determined as OK” is the largest in the evaluation of the predetermined driving operation within the predetermined section.

Further, in the above-described embodiment, the accelerator operation and the brake operation are evaluated, but the present disclosure is not limited to this. For example, driving operations such as steering operation, dangerous operation, signal observance, and sign observance may be set as operations to be evaluated.

Furthermore, various processors other than the CPU 20 may execute the process in which the CPU 20 reads and executes the program in the above embodiment. In this case, a programmable logic device (PLD) in which a circuit configuration can be changed after manufacturing, such as a field-programmable gate array (FPGA), and a dedicated electric circuit or the like that is a processor having a circuit configuration specially designed to execute a specific process, such as an application specific integrated circuit (ASIC), are exemplified as a processor. In addition, the above processes may be executed by one of these various processors, or may be executed by a combination of two or more processors of the same kind or different kinds. For example, the processes may be executed by a plurality of FPGAs, a combination of the CPU and the FPGA, and the like. Furthermore, the hardware structure of each of the various processors is, more specifically, an electric circuit in which circuit elements such as semiconductor elements are combined.

In the above embodiment, the storage 26 is configured to store various data. However, the present disclosure is not limited to this. For example, a non-transitory recording medium (storage medium) such as a compact disc (CD), a digital versatile disc (DVD), and a universal serial bus (USB) may be used as a storage unit. In this case, various programs, data, and the like are stored in these recording media.

What is claimed is:

1. A driving evaluation display device comprising:
an evaluation acquisition unit that acquires an evaluation result of a driving operation of a driver based on operation data regarding the driving operation during traveling; and
a display control unit that causes a display unit provided forward of a driver's seat to display an evaluation image indicating the evaluation result acquired by the evaluation acquisition unit, wherein the display control unit causes the evaluation image to be displayed in conjunction with a start of the driving operation by the driver, and changes a display mode of at least a part of the evaluation image based on the evaluation result.

2. The driving evaluation display device according to claim 1, wherein:
the evaluation image is a graphic image; and
the display control unit distorts a shape of the evaluation image based on the evaluation result.

3. The driving evaluation display device according to claim 1, wherein:
the evaluation image is a graphic image; and
the display control unit changes a color of an outer peripheral portion of the evaluation image based on the evaluation result.

4. The driving evaluation display device according to claim 1, wherein when a driving state of a vehicle changes from a traveling state to a stopped state, the display control unit causes the display unit to display an evaluation distribution image showing a distribution of evaluation results for a plurality of driving operations in a predetermined section.

5. A driving evaluation display method comprising:
acquiring an evaluation result of a driving operation of a driver based on operation data regarding the driving operation during traveling; and
displaying an evaluation image indicating the acquired evaluation result on a display unit provided forward of a driver's seat, wherein the evaluation image is displayed in conjunction with a start of the driving operation by the driver, and a display mode of at least a part of the evaluation image is changed based on the evaluation result.

6. A non-transitory storage medium storing a driving evaluation display program that causes a computer to execute processes comprising:
acquiring an evaluation result of a driving operation of a driver based on operation data regarding the driving operation during traveling; and
displaying an evaluation image indicating the acquired evaluation result on a display unit provided forward of a driver's seat, wherein the evaluation image is displayed in conjunction with a start of the driving operation by the driver, and a display mode of at least a part of the evaluation image is changed based on the evaluation result.
